(19) United States
(12) Patent Application Publication
(10) Pub. No.: US 2012/0122707 A1
(43) Pub. Date: May 17, 2012

(54) HIGH THROUGHPUT APPROACH TO FORMULATION USING PRE-DESIGNED FORMULATION PLATES

(76) Inventors: Rajiv Nayar, Danville, CA (US); Mitra Mosharraf, Danville, CA (US)

(21) Appl. No.: 13/299,355

(22) Filed: Nov. 17, 2011

Related U.S. Application Data
(60) Provisional application No. 61/414,890, filed on Nov. 17, 2010.

(51) Int. Cl. C40B 30/00; C40B 40/10; C40B 60/12

(52) U.S. Cl. 506/7; 506/39; 506/18

(57) ABSTRACT

System and methods provide formulation using pre-designed formulation plates for rapidly formulating proteins and peptides, wherein proteins are added to a plurality of wells in the plate; means for stressing one or more protein formulations; and means for analyzing samples of the protein formulations.

This application claims priority to U.S. Provisional Application Ser. No. 61414890 filed Nov. 17, 2010, the content of which is incorporated by reference.

### BACKGROUND OF THE INVENTION

The present invention relates to pre-formulation and formulation development and, more particularly, to stabilizing proteins, peptides, and other biomolecules or drug entities that are sensitive to formulation composition.

Proteins are an essential component of all living organisms, constituting the majority of all enzymes and functional elements of every cell. Each protein is an unbranched polymer of individual building blocks called amino acids. In general, there are 20 different natural amino acids, and each protein is a chain of from 50 to 1,000 amino acids. Hence there are many possible protein molecules. A simple bacterium will only employ a few hundred distinct proteins, while it is estimated that there are 50,000 distinct human proteins. In each case, the information for all these proteins is encoded in the DNA of every cell of the organism. By convention, the region of DNA coding for a single protein is called a “gene.” The machinery of the cell interprets the information in the DNA gene to string together the correct sequence of amino acids to form a particular protein. For natural proteins, the amino-acid sequence can be obtained directly from the sequence of DNA bases (A, C, T, G) in the gene for that protein via a known code.

Most formulation development is performed empirically or using the one-variable-at-a-time (OVAT) approach. This approach involves lots of resources, time, and money and also the data does not provide any information about the interactions between the variables that may be of importance in stabilizating the product. There are also numerous references to the use of Design of Experiments (DOE) methodology in formulation. Unfortunately, the DOE approach employed is usually used for screening of the formulation variables and does not typically result in identifying the optimal concentrations or conditions necessary for a stable protein/peptide formulation.

A number of commercial products use 96 well plates to perform various types of screens. These include screening for crystallization conditions for proteins, increasing solubility of proteins, and selecting of appropriate purification resins for protein purification. There are also numerous research publications on the use of DOE in protein formulations and protein solubility.

Dilyx Corporation provides an OptiForm Protein Formulation kit. This kit apparently provides the formulation preferences but does not describe the approach used. No use of DOE is described in the product info and based on their other products, it appears that the approach may be using the OVAT principle.

### SUMMARY OF THE INVENTION

In one aspect, systems and methods provide formulation using pre-designed formulation plates for rapidly formulating proteins and peptides, wherein proteins are added to a plurality of wells in the plate; means for stressing one or more protein formulations; and means for analyzing samples of the protein formulations.

In another aspect, there is provided a iFormulate plate for the purpose of providing the formulation scientish a pre-designed formulation plate for assessing the stability of a protein drug using DOE methodology. The basic plate consists of 20 unique formulation and 5 replicate formulations (for statistical data verification). The formulations are placed randomly to remove any bias. The DOE (Design of Experiments) is a response-surface multivariate design that evaluates the effect of pH, ionic strength, buffer and stabilizer concentration on the protein of interest.

Advantages of the system may include one or more of the following. The use of the iFormulate plate does not require any training in DOE methodology or statistics BUT does require the user to know how to analyze your protein and what is/are the crucial stability-indicating assays. It also saves the scientist time in preparation of 20 unique formulations as these have already been prepared for the plate user.

The use of iFormulate process requires adding the protein to the various formulations (25 total wells in a 96-well plate), stressing the protein to destabilize it or aggregate it a bit, and analyzing the 25 formulations using a stability-indicating assay(s). The process of iFormulate is shown in FIG. 1.

The formulation plate offers a number of benefits. First, the user does not need any prior knowledge of using DOE. The plate design has been constructed using an advanced DOE design. Second, the user does not need to prepare the large number (at least 20 or more) of unique formulations that the protein or peptide will be formulated in. The plate comes pre-loaded with these formulations and the formulations are randomly placed and have replicates to ensure that the results can be analyzed statistically. Third, the plate is designed to have the minimum number of statistically valid formulations for maximum amount of information that can be extracted from the data. Forth, the analysis of the data generated from the formulations can be done quickly.

The system also provides a convenient approach to rapidly formulate a protein or peptide using limited material, resources, and time. The system enables a rational approach to formulation that using advanced DOE principles and provides justification for the formulation components necessary to stabilize the protein. The preferred approach is simple enough to perform formulation development on limited quantities of protein without requiring the user to be an expert in DOE methodology and a statistician.

Other benefits of one embodiment called the iFormulate plate may include one or more of the following:

1. Pre-designed multivariate formulation plate that evaluates 4 critical formulation variables; pH, ionic strength, stabilizer concentration, and buffer concentration.

2. Evaluation performed on a minimum number of trials (20) with 5 replicate formulations at key points so that the results can be statistically validated.

3. Minimal amounts of protein required. For a 1 mg/ml solution—needs less 10 mg of protein (actually 7.5 mg).

4. Have enough formulation volume for a number of analyses.

5. The pre-designed plate saves time, money, and resources and provides maximum number of results with a minimum amount of experimental trials WITHOUT compromising on the quality of data because it can be statistically evaluated for inherent and assay errors.

6. Depending on the assays or analytical technique, time savings are significant 70-90% estimated time savings.

7. Evaluation of the data is easy using an appropriate DOE software.

8. The system provides a rationale and justification for the formulation using Quality by Design principles.

### BRIEF DESCRIPTION OF THE DRAWINGS

A complete understanding of the preferred embodiments may be obtained by reference to the accompanying drawings, when considered in conjunction with the subsequent, detailed description, in which:

FIG. 1 shows an exemplary plate for rapid rational formulation development.

FIG. 2 shows an exemplary process flow using the plate of FIG. 1 to optimize a protein formulation.

FIG. 3 shows an exemplary formulation plate with 2 sets of formulations.

FIG. 4 shows an exemplary DOE analysis process.

For purposes of clarity and brevity, like elements and components will bear the same designations and numbering throughout the Figures.

### DESCRIPTION OF THE PREFERRED EMBODIMENT

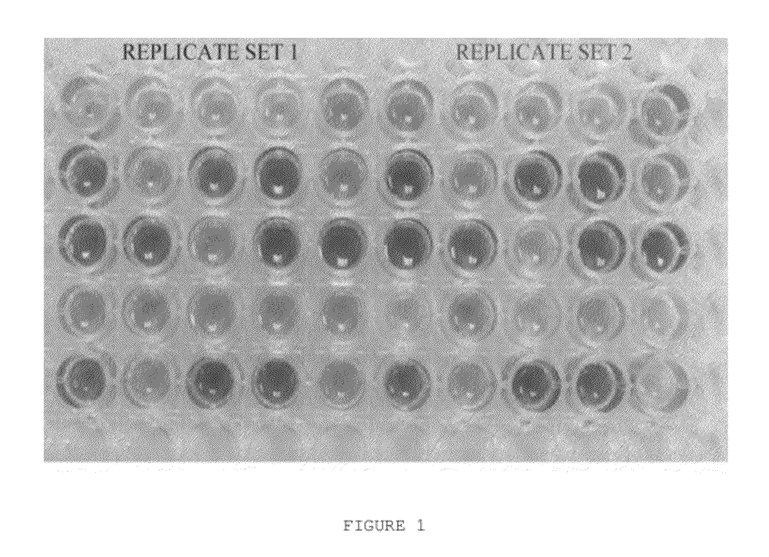

FIG. 1 shows an exemplary plate for rapid rational formulation development. In one embodiment called an iFormulate plate, two replicate sets of 20 unique+5 replicate formulations are formed in a 5 well×5 well format. The formulations are arranged randomly to remove any bias from the experiment and improve the statistical power of the design. A pH indicator is provided in the plate of FIG. 1 to illustrate the different pHs in the formulations.

The iFormulate plate evaluates 4 critical formulation parameters that are important to optimize in most protein/peptide formulations. These are pH, ionic strength, buffer concentration, and stabilizer (e.g. sugar) concentration. The pharmaceutically-acceptable conditions for proteins/peptides are pH ranges between 5-8, ionic strengths between 0-200 mM, buffer concentrations between 10-50 mM, and sugar concentration 0-10 wt %. These parameters allow the user to develop a stable protein formulation that could be isotonic (i.e. suitable for injection) and use of excipients that are generally regarded as safe (GRASS) for pharmaceutical compositions.

A response-surface multivariate design is used to generate the formulations for iFormulate. This DOE design is high level design over commonly used screening designs and specifically can elucidate any important interactions between the formulation variables. In contrast, a screening design, which is commonly used in protein DOE designs is a lower level design that just ranks the formulation variables in order of importance and does not provide any interaction effects between the variables. In addition, t the 20 unique formulations using the response-surface design, 5 replicate formulations from the 20 formulations are added to the design to include statistical power to the data set. These replicate aid in the validation of the data being generated from the iFormulate formulations and ensure that the conclusions made from this empirical data is valid.

The iFormulate plate contains a total of approximately 200-300 microliters of formulation so that adequate volume is available for multiple analysis. Also, the iFormulate plate is a UV transparent plate that can allow rapid analysis in a 96-well format that can be adopted in high throughput analytical systems, such as, a UV plate reader, HPLC system equipped to sample from 96-well plates, and other such analytical machines available in the high throughput analytics field.

The generation of multiple analytical data, such as, physical (protein aggregation, etc), chemical (oxidation, deamidation, etc), and bioactivity/potency from the iFormulate formulations allow analysis of combined experimental responses. For example, such a data set can be utilized to minimize protein aggregation and optimize protein integrity and bioactivity for a stable protein formulation.

In one embodiment, 20 unique formulations plus 5 replicates can be tested. Alternatively, 25 Total+any controls can be used in the empty wells. The 5 replicates ensures that the data is statistically valid. The protein should be at an appropriate concentration (typically 5×) as the protein will be diluted 5-fold in the formulation. Typically, 5-10 mg/ml protein is sufficient, as the system needs 1 ml of protein (40 ul/well×25 wells). The system also requires predetermined stress conditions to destabilize the protein. An appropriate stability-indicating assay can be used to analyze the formulations. 200 uL final volume can be used per formulation well. Using the system, a user can formulate a protein in an afternoon using protein aggregation as a stability-indicating assay with as little as 10 mg of protein. The advantage of the plate is that all formulations have already been made up and the design is specifically made to perform the minimum number of experimental trials generating the maximum amount of information to make a rational formulation decision. As a result, users can save at least 80% in time and resources using the iFormulate approach.

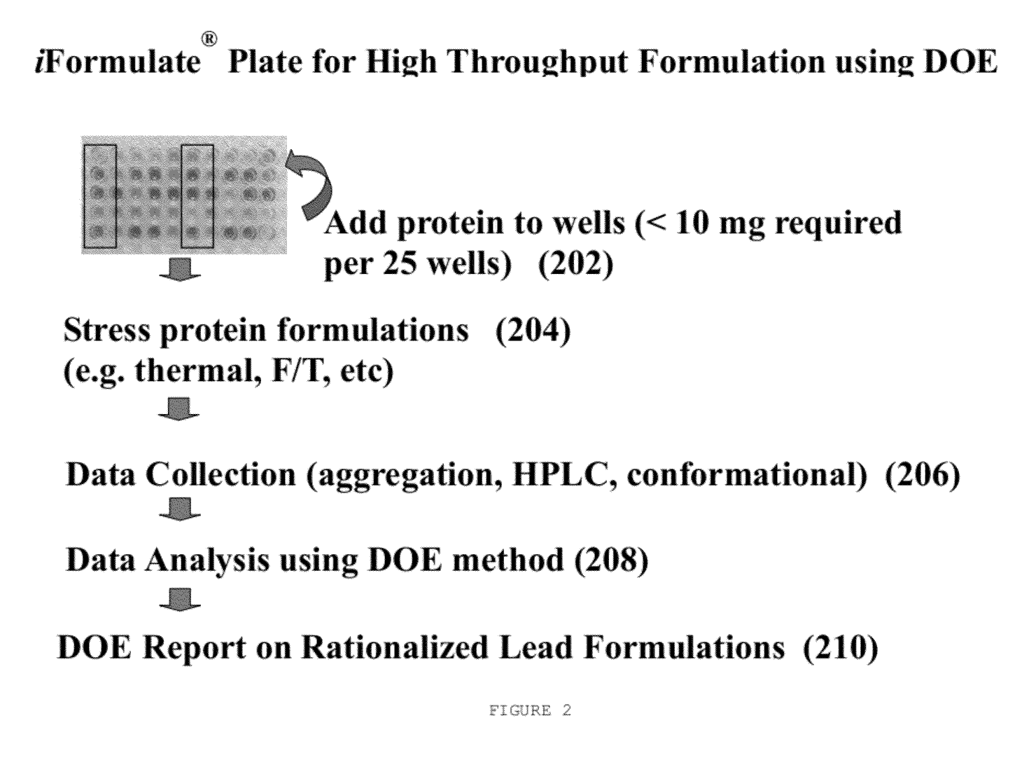

FIG. 2 is the process flow of using iformulate to optimize a protein formulation. The process adds proteins to a plurality of wells in the plate (202). Next, the process stresses one or more protein formulations (204). The stress can be thermal stress, for example. The process then analyzes samples of the protein formulations (206) and then applies a Design of Experiments (DOE) methodology to perform data analysis (208). The process then performs optimizing and rationalizing the one or more protein formulations (210).

In one embodiment, to the formulations (160 microliters per well), an aliquot of 40 microliters of protein solution (preferably in water) is added to the set of 25 wells. The plate is sealed and stressed by either thermal stress or any other stress that would partially destabilize the protein. The formulations from each of the 25 wells is analyzed using the appropriate stability-indicating assay by the user and the data is analyzed using DOE software. The results from such an experiment are compiled to show the ranking of importance of the four variables, any interactions between the formulation variables, and the optimal parameters necessary for a stable protein formulation.

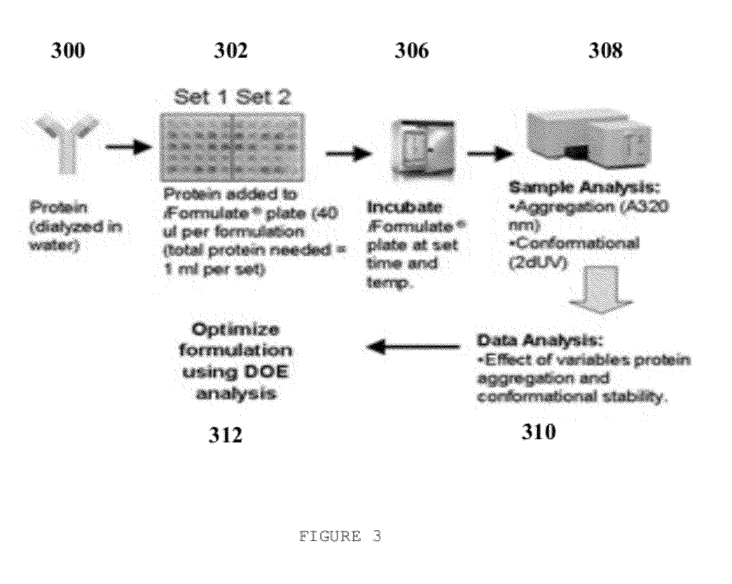

FIG. 3 shows an exemplary formulation plate with 2 sets of formulations. The protein is dialyzed in water (300). In FIG. 3, the formulation plate has 2 sets of the formulations (5×5) with a pH indicator added to show formulations at different pHs. Next, protein is added to the plate (302). The plate and protein are incubated at a set time and temperature (306). Sample analysis is done (308) to determine aggregation and conformational changes, among others. Next, data analysis is performed to find effects of variables on protein aggregation and conformational stability, for example (310). The system can optimize the formulation with DOE analysis.

One embodiment called the iFormulate protocol is easy to follow. Steps include ADD, STRESS, COLLECT DATA and Email data to data@iformulate.net for free DOE analysis and report. The protocol is:

1. ADD protein (preferably in a simple solution) 40 ul per well from a stock concentration of around >5 mg/ml (dilution of protein is 5×). This gives 1 mg/ml protein solution in each well.

2. STRESS the protein in various formulations (common stress is heating 10 C below the melting temperature until it is about 30-50% destabilized).

3. COLLECT data from each well using a stability-indicating assay (e.g. protein aggregation, bioactivity, integrity, content, among others)

4. EMAIL data to data@iformulate.net and RECEIVE a DOE analysis report on Pareto analysis (ranking of key variables), optimal pH, ionic strength, stabilizer concentration, and buffer concentration.

5. Validate the lead formulations proposed from the DOE data.

The iFormulate plate is a product for the purpose of providing the formulation as a pre-designed formulation plate for assessing the stability of a protein drug using DOE methodology. The basic plate consists of 20 unique formulation and 5 replicate formulations (for statistical data verification). The formulations are placed randomly to remove any bias. The DOE (Design of Experiments) is a response-surface multivariate design that evaluates the effect of pH, ionic strength, buffer and stabilizer concentration on the protein of interest. Use of the iFormulate plate does not require any training in DOE methodology or statistics BUT does require the user to know how to analyze their protein and what is/are the crucial stability-indicating assays. The process also saves the scientist time in preparation of 20 unique formulations as these have already been prepared for the plate user. The iFormulate Advantage may include one or more of the following:
Saves time, resources, and money without compromising on QUALITY. Estimated savings of more than 70%
Minimum number of trials giving you the maximum amount of information!
No need to make up the formulations.
Just need 1-5 mg protein.
No need to be an expert on DOE analysis.
Provides a justification and rationale for the formulation selection.

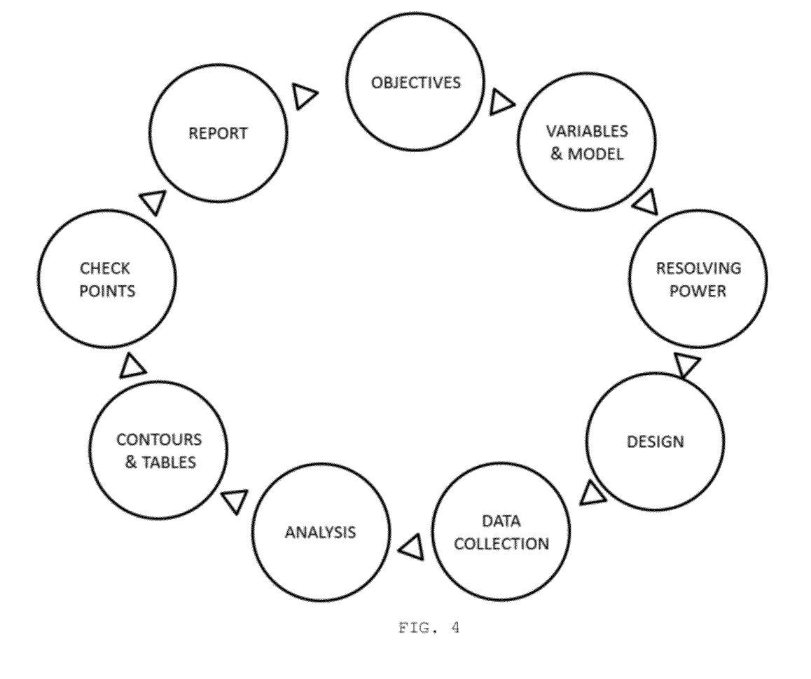

FIG. 4 shows an exemplary DOE analysis process. A DOE analysis report can provide information on Pareto analysis (ranking of key variables), optimal pH, ionic strength, stabilizer concentration, and buffer concentration.

The DOE methods reveal the complicated array of multifactor interactions involved in bioprocess development. Some experiments conducted include the use of high-throughput tools such as a robotically controlled microbioreactor system capable of conducting hundreds of simultaneous bioreactor experiments. The DOE strategy combined with the right tools can be used to identify optimal formulations and operating conditions to maximize product output. DOE greatly reduces the number of experiments and thus the time needed to optimize many variables. Some of our methods present results in the form of a response surface map, which makes it possible for researchers to quickly zero in on the optimal value of each factor. DoE also provides valuable understanding of the design space: the possible operating intervals of all factors during a final application. Such information, which could not be easily obtained before DoE, will help process developers establish threshold levels for robust manufacturing.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method to provide formulation using pre-designed formulation plates for rapidly formulating proteins and peptides, comprising:
adding proteins to a plurality of wells in the plate;
stressing one or more protein formulations;
analyzing samples of the protein formulations;
applying a Design of Experiments (DOE) methodology to perform data analysis; and
optimizing and rationalizing the one or more protein formulations.

2. The method of claim 1, comprising using multivariate analysis to optimize ph, ionic strength, buffer concentration, stabilizer concentration, or any other excipients using design of experiments methodology.

3. The method of claim 1, comprising collecting data from each formulation using stability-indicating assay(s).

4. The method of claim 1, comprising arranging formulations randomly to remove any bias from an experiment and improve the statistical power of a design.

5. The method of claim 1, comprising providing a pH indicator in the plate to illustrate different pHs in the formulations.

6. The method of claim 1, comprising evaluates critical formulation parameters that are important to optimize in most protein/peptide formulations.

7. The method of claim 6, wherein the parameters comprise pH, ionic strength, buffer concentration, and stabilizer concentration.

8. The method of claim 7, comprising providing pharmaceutically-acceptable conditions for proteins/peptides with pH ranges between 5-8, ionic strengths between 0-200 mM, buffer concentrations between 10-50 mM, and sugar concentration 0-10 wt %.

9. The method of claim 1, comprising using a response-surface multivariate design to generate the formulations.

10. The method of claim 1, comprising preloading the plate with formulations designed by DOE for rational formulation.

11. A system to provide a formulation, comprising
pre-designed formulation plates for rapidly formulating proteins and peptides, wherein proteins are added to a plurality of wells in the plate;
means for stressing one or more protein formulations; and
means for analyzing samples of the protein formulations.

12. The system of claim 11, comprising multivariate analysis means to optimize ph, ionic strength, buffer concentration, stabilizer concentration, or any other excipients using design of experiments methodology.

13. The system of claim 11, comprising stability-indicating assay(s) to collect data from each formulation.

14. The system of claim 11, comprising means for arranging formulations randomly to remove any bias from an experiment and improve the statistical power of a design.

15. The system of claim 11, comprising a pH indicator in the plate to illustrate different pHs in the formulations.

16. The method of claim 1, comprising means for evaluating critical formulation parameters that are important to optimize in most protein/peptide formulations.

17. The system of claim 16, wherein the parameters comprise pH, ionic strength, buffer concentration, and stabilizer concentration.

18. The system of claim 17, comprising a housing for providing pharmaceutically-acceptable conditions for proteins/peptides with pH ranges between 5-8, ionic strengths between 0-200 mM, buffer concentrations between 10-50 mM, and sugar concentration 0-10 wt %.

19. The system of claim 11, wherein the plate is preloaded with formulations designed by DOE for rational formulation.

20. A plate, comprising:
A plate of pre-designed formulation using a response surface DOE design; and
Wherein the plate comprises liquid or lyophilized formulations.
